(19) United States
(12) Patent Application Publication
(10) Pub. No.: US 2024/0264594 A1
(43) Pub. Date: Aug. 8, 2024

(54) AUTONOMOUS DRIVING CONTROL APPARATUS AND METHOD THEREOF

(71) Applicants: Hyundai Motor Company, Seoul (KR); Kia Corporation, Seoul (KR)

(72) Inventors: Hwan Hee Lee, Gunpo-Si (KR); Yun Sub Kim, Suwon-Si (KR); Ga Hee Kim, Seoul (KR); Seung Yong Lee, Uiwang-Si (KR)

(21) Appl. No.: 18/206,258

(22) Filed: Jun. 6, 2023

(30) Foreign Application Priority Data
Feb. 3, 2023 (KR) 10-2023-0015061

(51) Int. Cl. G05D 1/02; G06V 20/50; G06V 30/19

(52) U.S. Cl. CPC G05D 1/0246; G06V 20/50; G06V 30/19007

(57) ABSTRACT

Disclosed is an autonomous driving control apparatus which includes at least one sensor, one or more processors, and memory. The autonomous driving control apparatus obtains, using the at least one sensor and while a driving device is being autonomously controlled, data about a driving route of the driving device, stops a movement of the driving device based on a comparison between the cumulative quantity of the edge pairs identified along the driving route and edge pair data previously stored in the memory, obtains, using the at least one sensor, at least one image, and determines, based on the at least one image, that the driving device has reached a destination.

### CROSS-REFERENCE TO RELATED APPLICATION

This application claims the benefit of priority to Korean Patent Application No. 10-2023-0015061, filed in the Korean Intellectual Property Office on Feb. 3, 2023, the entire contents of which are incorporated herein by reference.

### TECHNICAL FIELD

The present disclosure relates to an autonomous driving control apparatus and a method thereof, and more particularly, relates to determining whether a driving device (e.g., a mobile robot) reaches a destination.

### BACKGROUND

With the development of technology, various technologies about a driving device have been developed. For example, as more pieces of data are used to control driving of the driving device to a destination, various methods for data processing have been developed.

The driving device may be implemented as various types. For example, various driving devices, such as an autonomous vehicle, a mobile robot, and an unmanned aerial vehicle, may be implemented such that drivers can remotely perform driving control without directly controlling driving.

Particularly, the mobile robot may be used in various environments. For example, the mobile robot may move to a specified room in a specified building (e.g., a hotel building). To control autonomous driving of the mobile robot, map data for a global activity radius of the mobile robot including a destination may be required.

However, when autonomous driving of the mobile robot is performed, there may be a limitation to performing rotation control such that the mobile robot is able to have the destination within the mobile robot's field of vision. For example, to control the mobile robot to rotate in a direction where the mobile robot looks at the destination, there is a need for a process of previously obtaining information about directions of the destination and the mobile robot as well as the location of the destination. Furthermore, as the number of rooms that can be designated as potential destinations increases, data processing for controlling a direction of the mobile robot may become rather complicated.

### SUMMARY

The present disclosure has been made to solve the above-mentioned problems occurring in the prior art while advantages achieved by the prior art are maintained intact.

An aspect of the present disclosure provides an autonomous driving control apparatus for determining whether a driving device (e.g., a mobile robot) reaches a destination using the number of edge pairs identified while driving, in a situation where driving of the driving device to a destination is controlled in a building where there are a plurality of rooms capable of being set to destinations on a driving route, for example, a hotel building and a method thereof.

Another aspect of the present disclosure provides an autonomous driving control apparatus for determining whether to stop autonomous driving using the number of edge pairs, rotating a driving device when it is determined to stop the autonomous driving, and determining whether the driving device reaches a destination based on at least one image obtained using a camera and a method thereof.

The technical problems to be solved by the present disclosure are not limited to the aforementioned problems, and any other technical problems not mentioned herein will be clearly understood from the following description by those skilled in the art to which the present disclosure pertains.

According to one or more embodiments of this disclosure, an autonomous driving control apparatus may include at least one sensor, one processors, or more and memory storing instructions. The instructions, when executed by the one or more processors, may cause the autonomous driving control apparatus to: obtain, using the at least one sensor and while a driving device is being autonomously controlled, data about a driving route of the driving device, the data comprising a cumulative quantity of edge pairs identified along the driving route; stop a movement of the driving device based on a comparison between: the cumulative quantity of the edge pairs identified along the driving route; and edge pair data previously stored in the memory; after stopping the movement of the driving device, obtain, using the at least one sensor, at least one image; and determine, based on the at least one image, that the driving device has reached a destination.

The edge pair data previously stored in the memory may include an edge pair quantity corresponding to the destination. The instructions, when executed by the one or more processors, may cause the autonomous driving control apparatus to: compare the cumulative quantity of the edge pairs identified along the driving route with the edge pair quantity corresponding to the destination; and stop the movement of the driving device based on the cumulative quantity of the edge pairs identified along the driving route being equal to the edge pair quantity corresponding to the destination.

The instructions, when executed by the one or more processors, may further cause the autonomous driving control apparatus to: rotate the driving device in place such that the destination is within directional range of the at least one sensor.

The instructions, when executed by the one or more processors, may cause the autonomous driving control apparatus to: obtain the at least one image while the driving device is rotating in place, wherein the at least one image includes room number information.

The instructions, when executed by the one or more processors, may further cause the autonomous driving control apparatus to: cause the driving device to stop rotating based on the room number information matching a room number corresponding to the destination.

The instructions, when executed by the one or more processors, may cause the autonomous driving control apparatus to: determine that the driving device has reached the destination based on the room number information matching a room number corresponding to the destination.

The instructions, when executed by the one or more processors, may cause the autonomous driving control apparatus to: provide, based on the determination that the driving device has reached the destination, a notification indicating arrival of the driving device at the destination.

The edge pair data previously stored in the memory includes at least one of: edge pair information for one or more left rooms in a building hallway, edge pair information for one or more right rooms in the building hallway, or room number information for the one or more left rooms and the one or more right rooms.

According to one or more embodiments of this disclosure, an autonomous driving control method may include: obtaining, by a controller using at least one sensor and while the controller is autonomously controlling a driving device, data about a driving route of the driving device, wherein the data includes a cumulative quantity of edge pairs identified along the driving route; stopping, by the controller, a movement of the driving device based on a comparison between: the cumulative quantity of the edge pairs identified along the driving route; and edge pair data previously stored in a memory associated with the controller; after stopping the movement of the driving device, obtaining, by the controller and using the at least one sensor, at least one image; and determining, by the controller and based on the at least one image, that the driving device has reached a destination.

The edge pair data previously stored in the memory may include an edge pair quantity corresponding to the destination. Stopping the movement of the driving device may include: comparing, by the controller, the cumulative quantity of the edge pairs identified along the driving route with the edge pair quantity corresponding to the destination; and stopping, by the controller, the movement of the driving device based on the cumulative quantity of the edge pairs identified along the driving route being equal to the edge pair quantity corresponding to the destination.

The autonomous driving control method may further include: rotating, by the controller, the driving device in place such that the destination is within directional range of the at least one sensor.

Obtaining of the at least one image may include obtaining the at least one image while the driving device is rotating in place, wherein the at least one image includes room number information.

The autonomous driving control method may further include: causing, by the controller, the driving device to stop rotating based on the room number information matching a room number corresponding to the destination.

Determining that the driving device has reached the destination may be based on the room number information matching a room number corresponding to the destination.

The autonomous driving control method may further include: providing, based on the determination that the driving device has reached the destination, a notification indicating arrival of the driving device at the destination.

According to one or more embodiments of this disclosure, a non-volatile computer-readable medium may store instructions that, when executed by one or more processors, cause an autonomous driving control apparatus to: obtain, using at least one sensor and while the autonomous driving control apparatus is autonomously controlling a driving device, data about a driving route of the driving device, wherein the data includes a cumulative quantity of edge pairs identified along the driving route; stopping a movement of the driving device based on a comparison between: the cumulative quantity of the edge pairs identified along the driving route; and edge pair data previously stored in a memory associated with the autonomous driving control apparatus; after stopping the movement of the driving device, obtaining, using the at least one sensor, at least one image; and determining, based on the at least one image, that the driving device has reached a destination.

The edge pair data previously stored in the memory may include an edge pair quantity corresponding to the destination, and wherein the instructions, when executed by the one or more processors, cause the autonomous driving control apparatus to stop the movement of the driving device by: comparing the cumulative quantity of the edge pairs identified along the driving route with the edge pair quantity corresponding to the destination; and stopping the movement of the driving device based on the cumulative quantity of the edge pairs identified along the driving route being equal to the edge pair quantity corresponding to the destination.

The instructions, when executed by the one or more processors, may further cause the autonomous driving control apparatus to: rotate the driving device in place such that the destination is within directional range of the at least one sensor.

The instructions, when executed by the one or more processors, may further cause the autonomous driving control apparatus to: obtain the at least one image while the driving device is rotating in place, wherein the at least one image includes room number information.

The instructions, when executed by the one or more processors, may further cause the autonomous driving control apparatus to: cause the driving device to stop rotating based on the room number information matching a room number corresponding to the destination.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating components of an autonomous driving control apparatus;

FIG. 2 is an operational conceptual diagram of an autonomous driving control apparatus;

FIG. 2 is an operational conceptual diagram of an autonomous driving control apparatus;

FIG. 4 is an operational conceptual diagram of an autonomous driving control apparatus;

FIG. 5 is an operational flowchart of an autonomous driving control apparatus;

FIG. 6 is an operational flowchart of an autonomous driving control apparatus; and

FIG. 7 illustrates a computing system used for autonomous driving control.

With regard to description of drawings, the same or similar denotations may be used for the same or similar components.

### DETAILED DESCRIPTION

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

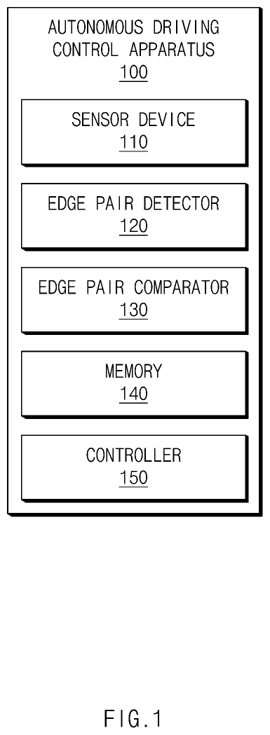

Hereinafter, embodiments of the present disclosure will be described in detail with reference to FIGS. 1 to 7.

FIG. 1 is a block diagram illustrating components of an autonomous driving control apparatus.

An autonomous driving control apparatus 100 may include at least one of a sensor device 110, an edge pair detector 120, an edge pair comparator 130, a memory 140, a controller 150, or a combination thereof. The components of the autonomous driving control apparatus 100, which are shown in FIG. 1, are illustrative, and embodiments of the present disclosure are not limited thereto. For example, the autonomous driving control apparatus 100 may further include components (e.g., at least one of an interface, a display, a sound output device, a communication device, or a combination thereof) which are not shown in FIG. 1. One or more of the elements described in FIG. 1 may be implemented with hardware, software, or a combination of both. One or more of the elements described in FIG. 1 may be combined with other element (s) described in FIG. 1.

The sensor device 110 may obtain (or sense) various pieces of information used about driving of a vehicle.

For example, the sensor device 110 may include at least one sensor including at least one of a camera, radar, light detection and ranging (LiDAR), or a combination thereof.

For example, the sensor device 110 may obtain information about an external object (e.g., at least one of a person, another vehicle, a building, a structure, or a combination thereof) using the at least one sensor.

For example, the sensor device 110 may obtain data about a driving environment and/or a driving route of a driving device (e.g., a mobile robot). As an example, the sensor device 110 may obtain data about the left and/or right of the driving device while the driving device is traveling (e.g., in a building hallway).

The edge pair detector 120 may detect information about an edge pair included in the data about the surrounding environment and/or the driving route of the driving device.

For example, the edge pair detector 120 may identify (or detect) the number (e.g., quantity) of edge pairs for each of the left and/or the right of the driving device, using the data obtained by means of the sensor device 110. An edge (also referred to as a “corner”) may be an intersection between two adjoining walls. An edge or a corner may be an intersection where two walls meet at an acute angle. Alternatively, an edge or a corner may be an intersection where two walls meet an obtuse angle.

For example, the edge pair detector 120 may accumulate and identify the number of edge pairs, continuously using the data obtained by means of the sensor device 110 while the driving device is traveling.

The edge pair comparator 130 may compare the number of the edge pairs identified (or detected) by the edge pair detector 120 with previously stored data.

For example, the edge pair comparator 130 may compare the number of the edge pairs identified by the edge pair detector 120 with edge pair data previously stored in the memory 140.

For example, the edge pair comparator 130 may compare an accumulated value of the number of edge pairs identified during autonomous driving of the driving device which is performing autonomous driving under control of the autonomous driving control apparatus 100 with the number of destination edge pairs included in the edge pair data previously stored in the memory 140. As an example, the number of the destination edge pairs may be the number of edge pairs that are present in a direction (e.g., the left or the right) corresponding to a destination with respect to the driving device, while the driving device is traveling from a point where autonomous driving starts from the destination.

As an example, the previously stored edge pair data may include at least one of edge pair information for each of left rooms, edge pair information for each of right rooms, room number information for each room, or a combination thereof with respect to a direction in which the driving device looks on a driving route (e.g., in a building hallway) of the driving device. The direction in which the driving device “looks” may refer to a direction that is within directional range (e.g., a field of vision) of the sensor device 110.

The memory 140 may store one or more instructions, when executed by the controller 150, causing the autonomous driving control apparatus 100 to perform various operations.

For example, the memory 140 and the controller 150 may be implemented as one chipset. The controller 150 may include at least one of a communication processor or a modem.

For example, the memory 140 may store various pieces of information associated with the autonomous driving control apparatus 100. As an example, the memory 140 may store information about an operation history of the controller 150.

For example, the memory 140 may store edge pair data. As an example, the edge pair data may include edge pair information in a place (e.g., the inside of a hotel) where there is the driving device. As an example, the edge pair data may include at least one of edge pair information for each of left rooms, edge pair information for each of right rooms, room number information for each room, or a combination thereof with respect to a direction at which the driving device looks on a driving route (e.g., in a building hallway) of the driving device.

The controller 150 may be operatively connected with the sensor device 110, the edge pair detector 120, the edge pair comparator 130, and/or the memory 140. For example, the controller 150 may control operations of the sensor device 110, the edge pair detector 120, the edge pair comparator 130, and/or the memory 140.

For example, the controller 150 may obtain data about a driving route of the driving device using the sensor device 110, while controlling autonomous driving of the driving device.

As an example, the controller 150 may control autonomous driving of the driving device to a destination. For example, the controller 150 may identify an input to the autonomous driving control apparatus 100 (e.g., at least one of an input received from an external device, a user input received from a user, or a combination thereof) and/or a destination determined by the controller 150 and may control autonomous driving of the driving device to the destination.

As an example, the data about the driving route may be divided into data about the left and data about the right with respect to the driving device. The controller 150 may continuously obtain data about the driving route of the driving device while performing the autonomous driving control of the driving device, using various sensors (e.g., LiDAR) included in the sensor device 110.

For example, the controller 150 may identify (or detect) information about an edge pair from the data obtained by means of the sensor device 110, using the edge pair detector 120.

As an example, the controller 150 may identify the number of edge pairs included in the data about the driving route, using the edge pair detector 120. The controller 150 may separately identify the number of edge pairs on the left and the number of edge pairs on the right with respect to the driving device (or with respect to a direction at which the driving device looks), using the edge pair detector 120.

For example, the controller 150 may compare the number of the identified edge pairs with edge pair data previously stored in the memory 140, using the edge pair comparator 130, to determine whether to stop the autonomous driving of the driving device.

As an example, the controller 150 may compare an accumulated value of the number of the edge pairs identified while performing autonomous driving control of the driving device with the number of destination edge pairs included in the previously stored edge pair data, using the edge pair comparator 130.

As an example, if the accumulated value of the number of the edge pairs identified while performing the autonomous driving control of the driving device is identical to the number of the destination edge pairs, the controller 150 may stop the autonomous driving of the driving device. The operation of stopping the autonomous driving may include, for example, an operation of controlling the driving device to stop movement.

For example, if it is determined to stop the autonomous driving of the driving device, the controller 150 may stop the movement of the driving device.

For example, after stopping the movement of the driving device, the controller 150 may obtain at least one image using the sensor device 110.

As an example, after the stopping the movement of the driving device, the controller 150 may rotate the driving device in place such that the direction at which the driving device looks (e.g., the direction in which the sensor device 110 is oriented towards) correspond to the destination. In other words, the controller 150 may rotate the driving device in place such that the destination is within directional range of the sensor device 110.

As an example, after the driving device stops the movement, there may be the destination on the left or the right with respect to the direction at which the driving device looks. For example, the controller 150 may identify whether there is a destination on any of the left or the right, using information about the destination of the driving device and may rotate the driving device in place in a direction such that the direction at which the driving device looks faster correspond to the destination. The information about the destination may be obtained based on, for example, an input to the autonomous driving control apparatus 100 (e.g., at least one of an input received from the external device, a user input received from the user, or a combination thereof).

For example, the controller 150 may obtain at least one image including room number information using the sensor device 110 while rotating the driving device in place.

As an example, the driving device may be traveling in a specified building including accommodations such as a hotel. Thus, the controller 150 may control the driving device to perform autonomous driving through a hallway of the specified building. The controller 150 may obtain at least one image including room number information of a room which is present on each of the left and/or the right of the hallway while rotating the driving device in place.

For example, the controller 150 may determine whether the room number information included in the at least one image is identical to destination room information corresponding to the destination.

As an example, the controller 150 may identify destination room information included in the information about the destination and may determine whether the room number information included in the at least one image obtained while rotating the driving device is identical to the destination room number.

For example, if the room number information included in the at least one image is identical to the destination room number corresponding to the destination, the controller 150 may stop rotating the driving device in place.

As an example, if the room number information included in the at least one image is identical to the destination room information, the controller 150 may determine that there is the destination room in the direction at which the driving device looks at a time point when the image is obtained (or determine that the driving device reaches the destination) and may stop rotating the driving device in place.

The components of the autonomous driving control apparatus 100, which are shown in FIG. 1, are illustrative, and embodiments of the present disclosure are not limited thereto. For example, the autonomous driving control apparatus 100 may further include a notification device (not shown).

For example, the notification device may include at least one of a sound output device, a display, or a combination thereof. The notification device may visually and/or audibly output, for example, various pieces of information about driving of the driving device to the outside.

For example, if it is determined that the driving device reaches the destination (or if the rotation of the driving device in place is stopped because the room number information included in the at least one image obtained while controlling the rotation of the driving device in place is identical to the destination room number), the controller 150 may output notification information about the arrival of the destination of the driving device to the outside using the 10 notification device.

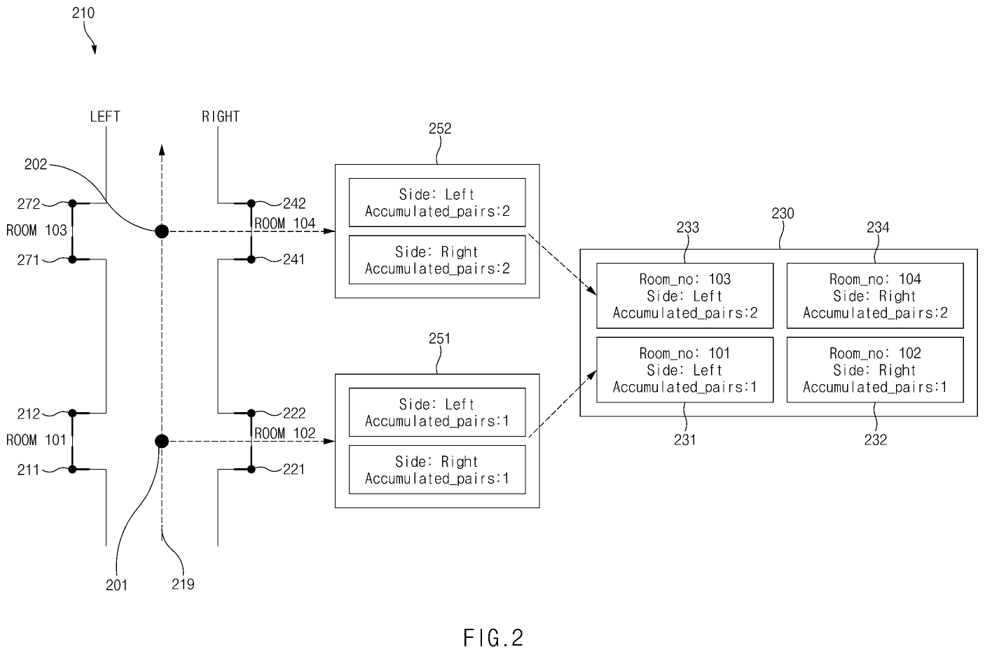

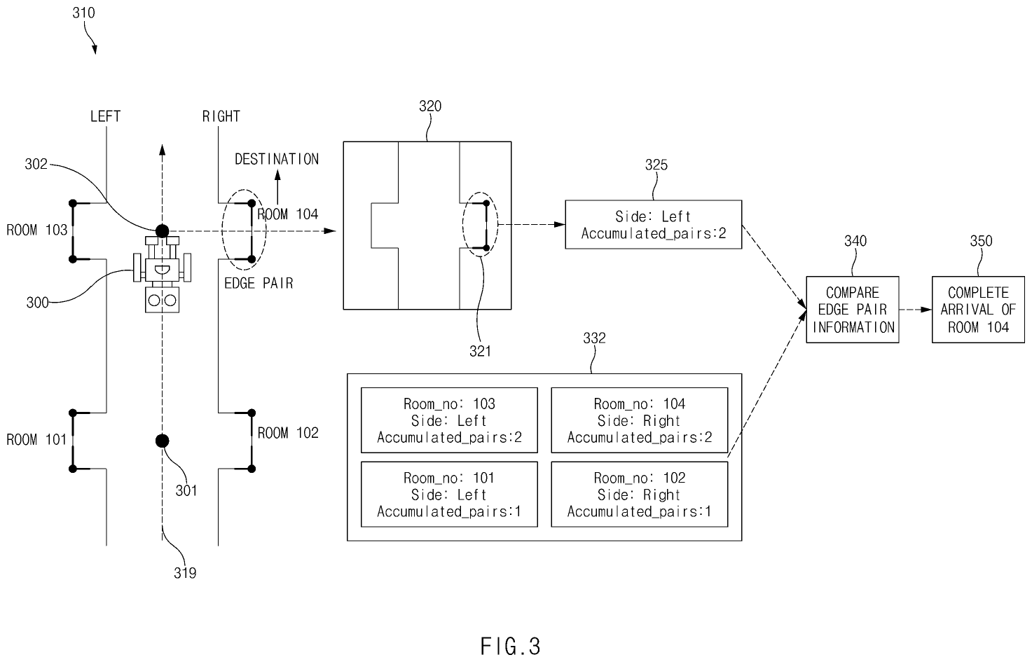

FIG. 2 is an operational conceptual diagram of an autonomous driving control apparatus.

Referring to reference numeral 210, the autonomous driving control apparatus (e.g., an autonomous driving control apparatus 100 of FIG. 1) may control autonomous driving of a driving device. The autonomous driving control apparatus may obtain data about a driving route 219 using a sensor device (e.g., a sensor device 110 of FIG. 1), while controlling the autonomous driving of the driving device.

For example, the autonomous driving control apparatus may perform autonomous driving control such that the driving device travels along the driving route 219 including a first point 201 and a second point 202 and may obtain various pieces of data about the driving route 219.

For example, the autonomous driving control apparatus may identify a 1-1st edge 211 and a 1-2nd edge 212, which are present on the left with respect to a direction at which the driving device looks at a time point when the driving device is traveling at the first point 201. For example, the autonomous driving control apparatus may identify that an accumulated value of the number of edge pairs on the left with respect to the first point 201 is “1” while controlling the driving device to the first point 201.

For example, the autonomous driving control apparatus may identify a 1-3rd edge 221 and a 1-4th edge 222, which are present on the right with respect to the direction at which the driving device looks at the time point when the driving device is traveling at the first point 201. For example, the autonomous driving control apparatus may identify that an accumulated value of the number of edge pairs on the right with respect to the first point 201 is “1” while controlling the driving device to the first point 201.

As an example, a table according to reference numeral 251 may be data about the number of edge pairs identified by the autonomous driving control apparatus at a time point when the driving device is traveling (or stopping) at the first point 201. For example, the data about the number of the edge pairs identified at the time point when the driving device is traveling at the first point 201 may include information that the accumulated value of the number of the edge pairs on the left with respect to the first point 201 corresponds to “1” and that the accumulated value of the number of the edge pairs on the right with respect to the first point 201 corresponds to “1”.

For example, the autonomous driving control apparatus may identify a 2-1st edge 271 and a 2-2nd edge 272, which are present on the left with respect to a direction at which the driving device looks at a time point when the driving device is traveling at a second point 202. For example, the autonomous driving control apparatus may identify that an accumulated value of the number of edge pairs on the left with respect to the second point 202 is “2” while controlling the driving device from the first point 201 to the second point 202.

For example, the autonomous driving control apparatus may identify a 2-3rd edge 241 and a 2-4th edge 242, which are present on the right with respect to the direction at which the driving device looks at the time point when the driving device is traveling at the second point 202. For example, the autonomous driving control apparatus may identify that the accumulated value of the number of the edge pairs on the right with respect to the second point 202 is “2” while controlling the driving device from the first point 201 to the second point 202.

As an example, a table according to reference numeral 252 may be data about the number of edge pairs identified by the autonomous driving control apparatus at a time point when the driving device is traveling (or stopping) at the first point 201 through the first point 201. For example, the data about the number of the edge pairs identified at the time point when the driving device is traveling at the second point 202 may include information that the accumulated value of the number of the edge pairs on the left corresponds to “2” and that the accumulated value of the number of the edge pairs on the right corresponds to “2”.

According to reference numeral 230, the autonomous driving control apparatus may generate edge pair information for each room based on the data identified (or obtained) about the driving route 219 and may match and store the edge pair room number information and location information with information (e.g., the left or the right) of each of a plurality of rooms.

For example, according to reference numeral 231, the autonomous driving control apparatus may generate information that Room 101 is present on the left with respect to the driving route 219 and that an accumulated value of the number of edge pairs corresponding to Room 101 corresponds to “1”.

For example, according to reference numeral 232, the autonomous driving control apparatus may generate information that Room 102 is present on the right with respect to the driving route 219 and that an accumulated value of the number of edge pairs corresponding to Room 102 corresponds to “1”.

For example, according to reference numeral 233, the autonomous driving control apparatus may generate information that Room 103 is present on the left with respect to the driving route 219 and that an accumulated value of the number of edge pairs corresponding to Room 103 corresponds to “2”.

For example, according to reference numeral 234, the autonomous driving control apparatus may generate information that Room 104 is present on the right with respect to the driving route 219 and that an accumulated value of the number of edge pairs corresponding to Room 104 corresponds to “2”.

The autonomous driving control apparatus may store data according to reference numeral 230 (or edge pair data) in a memory (e.g., a memory 140 of FIG. 1) and may use the data for autonomous driving of the driving device.

FIG. 3 is an operational conceptual diagram of an autonomous driving control apparatus.

Referring to reference numeral 310, the autonomous driving control apparatus (e.g., an autonomous driving control apparatus 100 of FIG. 1) may control autonomous driving of a driving device 300. The autonomous driving control apparatus may obtain data about a driving route 319 using a sensor device (e.g., a sensor device 110 of FIG. 1), while controlling the autonomous driving of the driving device 300.

Reference numeral 310 may be referred to as a situation where the autonomous driving control apparatus controls the driving device 300 along the driving route 319 from a first point 301 to a second point 302. Furthermore, the driving device 300 according to FIG. 3 may be referred to in a state where a destination is set to Room 104.

Reference numerals 320 and 325 may be drawings conceptually illustrating data obtained using the sensor device by the autonomous driving control apparatus at a time point when the driving device 300 is traveling at the second point 302.

For example, according to reference numeral 320, the autonomous driving control apparatus may identify an edge pair 321 which is present on the right with respect to a direction at which the driving device 300 looks using the sensor device in a situation where the driving device 300 is present at the second point 302. For example, although not illustrated, the autonomous driving control apparatus may further identify an edge pair (not shown) which is present on the left with respect to the direction at which the driving device 300 looks.

For example, according to reference numeral 325, the autonomous driving control apparatus may identify that an accumulated value of the number of edge pairs in a right direction at a time point when the driving device 300 is present at the second point 302, based on the data obtained using the sensor device.

For example, reference numeral 332 may be previously stored edge pair data. As an example, the autonomous driving control apparatus may compare the accumulated value (e.g., “2”) of the number of the edge pairs identified during the autonomous driving of the driving device 300 with the number of destination edge pairs included in the previously stored edge pair data. As an example, the previously stored edge pair data may be a combination of pieces of data obtained while the autonomous driving control apparatus previously controls the driving device 300 as shown in FIG. 2.

For example, according to reference numeral 340, the autonomous driving control apparatus may compare pieces of data according to reference numerals 320, 325, and 332. If the accumulated value is identical to (e.g., equal to) the number of the destination edge pairs, the autonomous driving control apparatus may determine to stop the autonomous driving of the driving device 300. As an example, the autonomous driving control apparatus may stop the movement of the driving device 300.

For example, according to reference numeral 350, in a situation where the destination is set to Room 104, because the accumulated value of the number of the edge pairs on the right identified during the autonomous driving of the driving device 300 is “2”, the location of Room 104 identified based on the previously stored edge pair data is the right, and the accumulated value of the number of edge pairs in Room 104 is “2”, the autonomous driving control apparatus may identify that the driving device 300 reaches Room 104 and may determine to stop the movement of the driving device 300 at the second point 302.

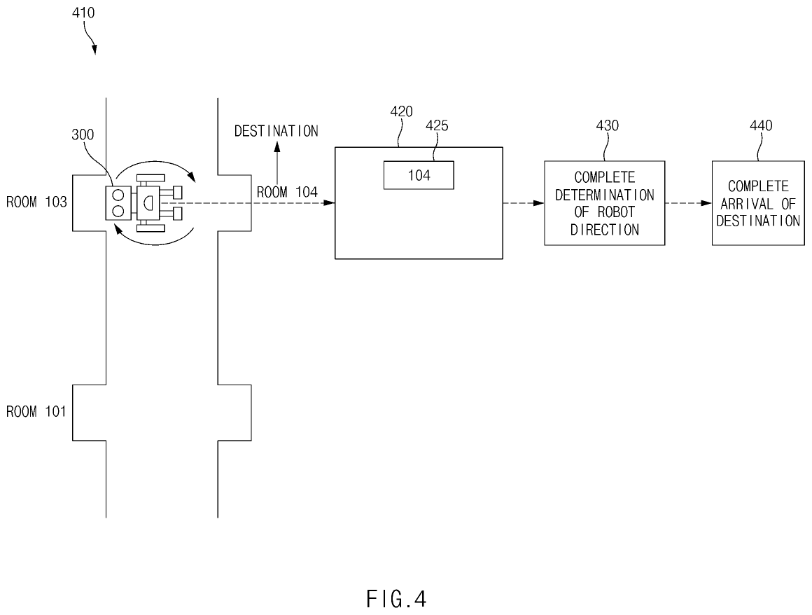

It is described that the autonomous driving control apparatus identifies that the driving device 300 reaches the destination (e.g., Room 104) depending on reference numeral 350 in FIG. 3, but embodiments of the present disclosure are not limited thereto. For example, in the state where the driving device 300 stops its movement at the second point 302, the autonomous driving control apparatus may determine whether the driving device 300 reaches the destination by further using at least one image obtained by means of rotation in place and at least some of pieces of previously stored edge pair data. Rotation of the driving device 300 in place will be described in detail in the description of FIG. 4 below.

FIG. 4 is an operational conceptual diagram of an autonomous driving control apparatus.

Referring to reference numeral 410, the autonomous driving control apparatus (e.g., an autonomous driving control apparatus 100 of FIG. 1) may control autonomous driving of a driving device 300. For example, the example shown in FIG. 4 may be referred to in a situation after the autonomous driving control apparatus stops movement of the driving device 300 at a second point 302 in FIG. 3. Furthermore, the driving device 300 according to FIG. 4 may be referred to in a state where a destination is set to Room 104.

The autonomous driving control apparatus may compare an accumulated value of the number of edge pairs identified during autonomous driving of the driving device 300 with the number of destination edge pairs included in previously stored edge pair data and may stop autonomous driving (or movement) of the driving device 300 if the accumulated value is identical to the number of the destination edge pairs.

After stopping the movement of the driving device 300, the autonomous driving control apparatus may rotate the driving device 300 in place, such that a direction at which the driving device 300 looks corresponds to the destination (e.g., Room 104).

For example, the autonomous driving control apparatus may stop forward and/or backward movement of the driving device 300 based on the comparison between the numbers of the edge pairs and may rotate the driving device 300 to control the driving device 300 to face a destination room.

The autonomous driving control apparatus may obtain at least one image including a room number while rotating the driving device 300 in place, using a sensor device.

For example, the driving device 300 according to FIG. 4 may obtain at least one image including an image corresponding to Room 103 and/or Room 104 while rotating at the shown point.

For example, an image according to reference numeral 420 may include an image corresponding to Room 104 and an image including a room number of Room 104.

Referring to reference numeral 430, the autonomous driving control apparatus may stop rotating the driving device 300 in place, if room number information 425 included in the at least one image is identical to a destination room number (Room 104). In other words, the autonomous driving control apparatus may identify that the driving device 300 (or a mobile robot) looks at the destination at a time point if the room number information 425 included in the at least one image obtained using the sensor device (or a camera) is identical to the destination room number (Room 104).

Referring to reference numeral 440, the autonomous driving control apparatus may determine that the driving device 300 reaches the destination. For example, if it is determined that the driving device 300 reaches the destination (or if the rotation of the driving device 300 in place is stopped because the room number information included in the at least one image obtained while controlling the rotation of the driving device 300 in place is identical to the destination room number), the autonomous driving control apparatus may visually and/or audible output notification information about the arrival of the destination of the driving device 300 to the outside using a notification device.

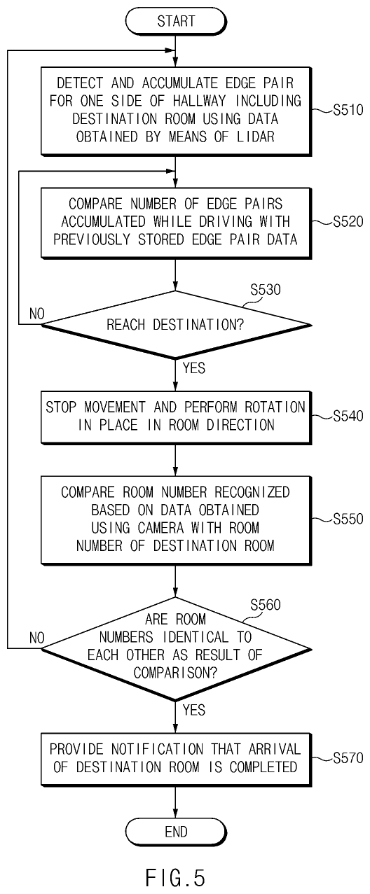

FIG. 5 is an operational flowchart of an autonomous driving control apparatus.

The autonomous driving control apparatus (e.g., an autonomous driving control apparatus 100 of FIG. 1) may perform operations disclosed in FIG. 5. For example, at least some of components (e.g., a sensor device 110 of FIG. 1, an edge pair detector 120 of FIG. 1, an edge pair comparator 130 of FIG. 1, a memory 140 of FIG. 1, a controller 150 of FIG. 1, or a combination thereof) included in the autonomous driving control apparatus may be configured to perform the operations of FIG. 5.

Operations in S510 to S570 may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 5, may be briefly described or omitted.

In S510, the autonomous driving control apparatus may detect and accumulate an edge pair for one side of a hallway including a destination room using data obtained by means of LiDAR.

As an example, the autonomous driving control apparatus may detect, accumulate, and store an edge pair for each of the left and the right of the hallway (or a driving route), which is obtained while controlling autonomous driving of a driving device, using the LiDAR (e.g., a sensor device 110 of FIG. 1).

In S520, the autonomous driving control apparatus may compare the number of edge pairs accumulated while driving with previously stored edge pair data.

For example, the autonomous driving control apparatus may compare an accumulated value of the number of edge pairs identified during autonomous driving of the driving device with the number of destination edge pairs included in the previously stored edge pair data, using an edge pair comparator.

In S530, the autonomous driving control apparatus may determine whether the driving device reaches a destination using the compared result.

For example, if the accumulated value is identical to the number of the destination edge pairs, the autonomous driving control apparatus may determine that the driving device reaches the destination (e.g., S530— YES). It is described that the autonomous driving control apparatus determines that the driving device reaches the destination if the accumulated value is identical to the number of the destination edge pairs in FIG. 5, but embodiments of the present disclosure are not limited thereto. For example, after room numbers are identical to each other as a result of the comparison in S560, the autonomous driving control apparatus may determine that the driving device reaches the destination. In other words, the determination whether the driving device reaches the destination in S530 may correspond to first-stage destination arrival determination, and the determination whether the driving device reaches the destination in S560 may correspond to final destination arrival determination.

For example, if the accumulated value is identical to the number of the destination edge pairs (or if it is determined that the driving device reaches the destination) (S530— YES), the autonomous driving control apparatus may perform S540.

For example, if the accumulated value is not identical to the number of the destination edge pairs (or if it is determined that the driving device does not reach the destination) (S530— NO), the autonomous driving control apparatus may repeatedly perform S520.

In S540, the autonomous driving control apparatus may stop movement of the driving device and may control the driving device to rotate in place in a room direction.

For example, the autonomous driving control apparatus may rotate the driving device in place such that the driving device looks at a destination room. A method for determining whether the driving device looks at the destination room will be described below in S550 and S560.

In S550, the autonomous driving control apparatus may compare a room number recognized based on data obtained using a camera with a room number of the destination room.

For example, the autonomous driving control apparatus may obtain at least one image using the camera, while rotating the driving device in place. At this time, the at least one image may include a room number of a room which is present around the driving device.

In S560, the autonomous driving control apparatus may determine whether the room numbers are identical to each other as a result of the comparison.

For example, the autonomous driving control apparatus may identify room number information included in the at least one image obtained by means of the rotation of the driving device. The autonomous driving control apparatus may compare whether the identified room number information is identical to the room number of the destination room.

For example, if the identified room number information is identical to the room number of the destination room (e.g., S560— YES), the autonomous driving control apparatus may perform S570.

For example, if the identified room number information is not identical to the room number of the destination room (e.g., S560— NO), the autonomous driving control apparatus may repeatedly perform S510.

In S570, the autonomous driving control apparatus may provide a notification that the arrival of the destination room is completed.

For example, if the room numbers are identical to each other as a result of the comparison in S560, the autonomous driving control apparatus may determine that the driving device finally reaches the destination. In other words, if it is determined that the driving device looks at the destination room, the autonomous driving control apparatus may determine that the driving device finally reaches the destination. Thus, the autonomous driving control apparatus may output notification information about the arrival of the destination of the driving device to the outside using a notification device.

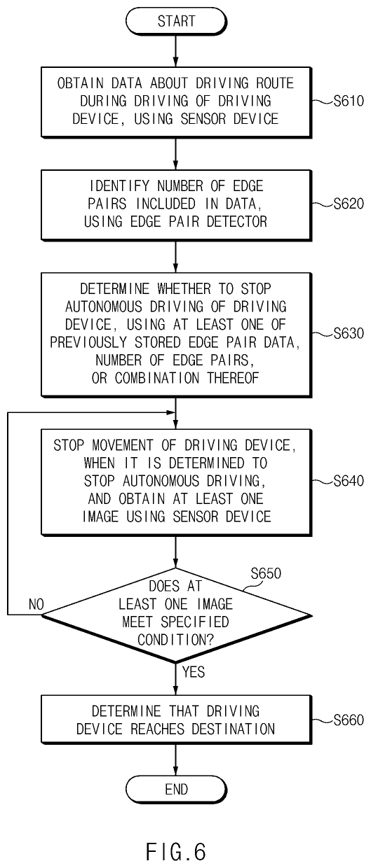

FIG. 6 is an operational flowchart of an autonomous driving control apparatus.

The autonomous driving control apparatus (e.g., an autonomous driving control apparatus 100 of FIG. 1) may perform operations disclosed in FIG. 6. For example, at least some of components (e.g., a sensor device 110 of FIG. 1, an edge pair detector 120 of FIG. 1, an edge pair comparator 130 of FIG. 1, a memory 140 of FIG. 1, a controller 150 of FIG. 1, or a combination thereof) included in the autonomous driving control apparatus may be configured to perform the operations of FIG. 6.

Operations in S610 to S660 may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 6, may be briefly described or omitted.

In S610, the autonomous driving control apparatus may obtain data about a driving route while a driving device is traveling, using a sensor device.

For example, the autonomous driving control apparatus may obtain data about an edge pair which is present on the left and/or the right of the driving route, using LiDAR included in the sensor device.

In S620, the autonomous driving control apparatus may identify the number of edge pair included in the data, using an edge pair detector.

For example, the autonomous driving control apparatus may accumulate data obtained while controlling autonomous driving of the driving device and may identify an accumulated value of the number of the edge pairs.

In S630, the autonomous driving control apparatus may determine whether to stop the autonomous driving of the driving device, using at least one of previously stored edge pair data, the number of the edge pairs, or a combination thereof.

For example, the autonomous driving control apparatus may compare an accumulated value of the number of edge pairs identified during the autonomous driving with the number of destination edge pairs included in the previously stored edge pair data.

For example, if the accumulated value is identical to the number of the destination edge pairs, the autonomous driving control apparatus may determine to stop the autonomous driving of the driving device.

In S640, if it is determined to stop the autonomous driving, the autonomous driving control apparatus may stop the movement of the driving device and may then obtain at least one image using the sensor device.

For example, if it is determined to stop the autonomous driving of the driving device, the autonomous driving control apparatus may stop the movement of the driving device and may then rotate the driving device in place such that a direction at which the driving device looks correspond to the destination.

In S650, the autonomous driving control apparatus may determine whether the at least one image meets a specified condition.

For example, the autonomous driving control apparatus may obtain at least one image including room number information while rotating the driving device in place and may stop rotating the driving device in place, if the room number information included in the at least one image is identical to a destination room number corresponding to the destination. In other words, if the room number information included in the at least one image is identical to the destination room number corresponding to the destination, the autonomous driving control apparatus may determine that the direction at which the driving device looks corresponds to the destination. Thus, at this time, the autonomous driving control apparatus may determine that the driving device reaches the destination.

For example, if the at least one image meets the specified condition (e.g., S650— YES), the autonomous driving control apparatus may perform S660.

For example, if the at least one image does not meet the specified condition (e.g., S650— NO), the autonomous driving control apparatus may repeatedly perform S640.

If the at least one image meets the specified condition, in S660, the autonomous driving control apparatus may determine the driving device reaches the destination.

For example, if it is determined that the driving device reaches the destination (or if the rotation of the driving device in place is stopped because the room number information included in the at least one image obtained while controlling the rotation of the driving device in place is identical to the destination room number), the autonomous driving control apparatus may output notification information about the arrival of the destination of the driving device to the outside using a notification device.

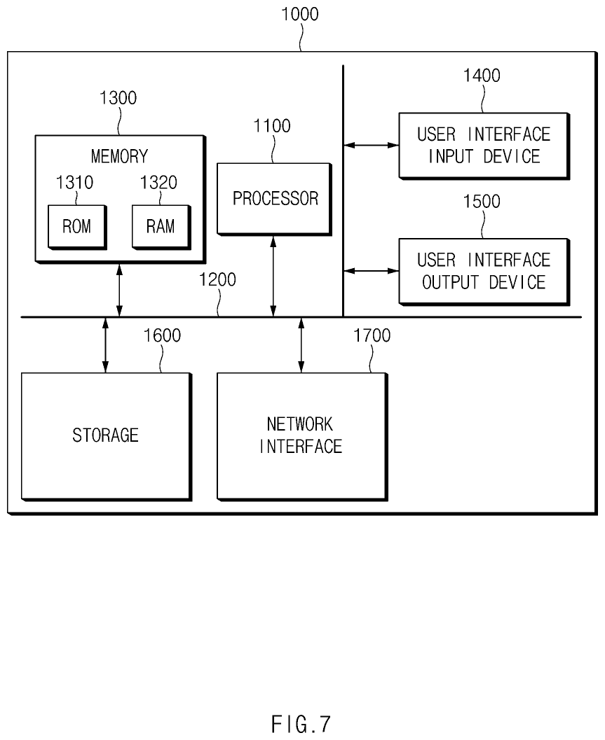

FIG. 7 illustrates a computing system used for autonomous driving control. A computing system 1000 may be used to implement one or more of the various devices and components described in the present disclosure. For example, the computing system 1000 may be used to implement one or more of: the autonomous driving control apparatus 100, the sensor device 110, the edge pair detector 120, the edge pair comparator 130, and/or the controller 150.

Referring to FIG. 7, the computing system 1000 about the autonomous driving control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description will be given of effects of the autonomous driving control apparatus and the method thereof according to one or more embodiments of the present disclosure.

According to one or more embodiments of the present disclosure, the autonomous driving control apparatus may reduce the amount of data necessary for a driving device (e.g., a mobile robot) to reach a destination or may simplify data processing, thus efficiently moving the driving device to the destination.

Furthermore, according to one or more embodiments of the present disclosure, the autonomous driving control apparatus may reduce a time taken to obtain destination-related data (e.g., destination coordinates) required to reach the destination by using edge pair data (e.g., the number of edge pairs) previously stored to control movement of the driving device.

Furthermore, according to one or more embodiments of the present disclosure, the autonomous driving control apparatus does not need to newly obtain or construct information about the destination, if a reference landmark (e.g., at least one of the number of edge pairs, a location of an edge pair, or a combination thereof) is maintained, although map data for movement of the driving device is updated, for example, if an environment where the driving device travels is changed.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An autonomous driving control apparatus comprising:
at least one sensor;
one or more processors; and
memory storing instructions that, when executed by the one or more processors, cause the autonomous driving control apparatus to:
obtain, using the at least one sensor and while a driving device is being autonomously controlled, data about a driving route of the driving device, the data comprising a cumulative quantity of edge pairs identified along the driving route;
stop a movement of the driving device based on a comparison between:
the cumulative quantity of the edge pairs identified along the driving route; and
edge pair data previously stored in the memory;
after stopping the movement of the driving device, obtain, using the at least one sensor, at least one image; and
determine, based on the at least one image, that the driving device has reached a destination.

2. The autonomous driving control apparatus of claim 1, wherein the edge pair data previously stored in the memory comprises an edge pair quantity corresponding to the destination, and wherein the instructions, when executed by the one or more processors, cause the autonomous driving control apparatus to:
compare the cumulative quantity of the edge pairs identified along the driving route with the edge pair quantity corresponding to the destination; and
stop the movement of the driving device based on the cumulative quantity of the edge pairs identified along the driving route being equal to the edge pair quantity corresponding to the destination.

3. The autonomous driving control apparatus of claim 1, wherein the instructions, when executed by the one or more processors, further cause the autonomous driving control apparatus to:
rotate the driving device in place such that the destination is within directional range of the at least one sensor.

4. The autonomous driving control apparatus of claim 1, wherein the instructions, when executed by the one or more processors, cause the autonomous driving control apparatus to:
obtain the at least one image while the driving device is rotating in place, wherein the at least one image comprises room number information.

5. The autonomous driving control apparatus of claim 4, wherein the instructions, when executed by the one or more processors, further cause the autonomous driving control apparatus to:
cause the driving device to stop rotating based on the room number information matching a room number corresponding to the destination.

6. The autonomous driving control apparatus of claim 4, wherein the instructions, when executed by the one or more processors, cause the autonomous driving control apparatus to:
determine that the driving device has reached the destination based on the room number information matching a room number corresponding to the destination.

7. The autonomous driving control apparatus of claim 1, wherein the instructions, when executed by the one or more processors, cause the autonomous driving control apparatus to:
provide, based on the determination that the driving device has reached the destination, a notification indicating arrival of the driving device at the destination.

8. The autonomous driving control apparatus of claim 1, wherein the edge pair data previously stored in the memory comprises at least one of:
edge pair information for one or more left rooms in a building hallway,
edge pair information for one or more right rooms in the building hallway, or
room number information for the one or more left rooms and the one or more right rooms.

9. An autonomous driving control method comprising:
obtaining, by a controller using at least one sensor and while the controller is autonomously controlling a driving device, data about a driving route of the driving device, wherein the data comprises a cumulative quantity of edge pairs identified along the driving route;
stopping, by the controller, a movement of the driving device based on a comparison between:
the cumulative quantity of the edge pairs identified along the driving route; and
edge pair data previously stored in a memory associated with the controller;
after stopping the movement of the driving device, obtaining, by the controller and using the at least one sensor, at least one image; and
determining, by the controller and based on the at least one image, that the driving device has reached a destination.

10. The autonomous driving control method of claim 9, wherein the edge pair data previously stored in the memory comprises an edge pair quantity corresponding to the destination, and wherein the stopping the movement of the driving device comprises:
comparing, by the controller, the cumulative quantity of the edge pairs identified along the driving route with the edge pair quantity corresponding to the destination; and
stopping, by the controller, the movement of the driving device based on the cumulative quantity of the edge pairs identified along the driving route being equal to the edge pair quantity corresponding to the destination.

11. The autonomous driving control method of claim 9, further comprising:
rotating, by the controller, the driving device in place such that the destination is within directional range of the at least one sensor.

12. The autonomous driving control method of claim 9, wherein the obtaining of the at least one image comprises obtaining the at least one image while the driving device is rotating in place, wherein the at least one image comprises room number information.

13. The autonomous driving control method of claim 12, further comprising:
causing, by the controller, the driving device to stop rotating based on the room number information matching a room number corresponding to the destination.

14. The autonomous driving control method of claim 12, wherein the determining that the driving device has reached the destination based on the room number information matching a room number corresponding to the destination.

15. The autonomous driving control method of claim 9, further comprising:
providing, based on the determination that the driving device has reached the destination, a notification indicating arrival of the driving device at the destination.

16. A non-volatile computer-readable medium storing instructions that, when executed by one or more processors, cause an autonomous driving control apparatus to:
obtain, using at least one sensor and while the autonomous driving control apparatus is autonomously controlling a driving device, data about a driving route of the driving device, wherein the data comprises a cumulative quantity of edge pairs identified along the driving route;
stopping a movement of the driving device based on a comparison between:
the cumulative quantity of the edge pairs identified along the driving route; and
edge pair data previously stored in a memory associated with the autonomous driving control apparatus;
after stopping the movement of the driving device, obtaining, using the at least one sensor, at least one image; and
determining, based on the at least one image, that the driving device has reached a destination.

17. The non-volatile computer-readable medium of claim 16, wherein the edge pair data previously stored in the memory comprises an edge pair quantity corresponding to the destination, and wherein the instructions, when executed by the one or more processors, cause the autonomous driving control apparatus to stop the movement of the driving device by:
comparing the cumulative quantity of the edge pairs identified along the driving route with the edge pair quantity corresponding to the destination; and
stopping the movement of the driving device based on the cumulative quantity of the edge pairs identified along the driving route being equal to the edge pair quantity corresponding to the destination.

18. The non-volatile computer-readable medium of claim 16, wherein the instructions, when executed by the one or more processors, further cause the autonomous driving control apparatus to:
rotate the driving device in place such that the destination is within directional range of the at least one sensor.

19. The non-volatile computer-readable medium of claim 16, wherein the instructions, when executed by the one or more processors, further cause the autonomous driving control apparatus to:
obtain the at least one image while the driving device is rotating in place, wherein the at least one image comprises room number information.

20. The non-volatile computer-readable medium of claim 19, wherein the instructions, when executed by the one or more processors, further cause the autonomous driving control apparatus to:
cause the driving device to stop rotating based on the room number information matching a room number corresponding to the destination.
